(19) United States
(12) Patent Application Publication
(10) Pub. No.: US 2013/0099716 A1
(43) Pub. Date: Apr. 25, 2013

(54) MOTOR DRIVING APPARATUS

(71) Applicant: Bon Young KOO, Suwon (KR)

(72) Inventor: Bon Young KOO, Suwon (KR)

(73) Assignee: SAMSUNG ELECTRO-MECHANICS CO., LTD.

(21) Appl. No.: 13/352,988

(22) Filed: Jan. 18, 2012

(30) Foreign Application Priority Data
Oct. 25, 2011 (KR) 10-2011-0109185

(51) Int. Cl. H02P 7/29

(52) U.S. Cl. 318/503

(57) ABSTRACT

There is provided a motor driving apparatus. The motor driving apparatus includes: a duty adjusting unit adjusting a duty of a PWM signal in response to a detection signal from a hall sensor, adjusting a duty value in a partial period of the entire duty period to be higher than a target duty value that is to be controlled and a duty value in another partial period thereof to be lower than the target duty value that is to be controlled, and adjusting an average duty value in the entire duty period to follow the target duty value; a signal generating unit receiving a PWM control signal and generating the PWM signal of which the duty is adjusted according to the adjustment of the duty; and a driving controlling unit controlling driving of a motor in response to the detection signal of the hall sensor and the PWM signal.

### CROSS-REFERENCE TO RELATED APPLICATIONS

This application claims the priority of Korean Patent Application No. 10-2011-0109185 filed on Oct. 25, 2011 in the Korean Intellectual Property Office, the disclosure of which is incorporated herein by reference.

### BACKGROUND OF THE INVENTION

1. Field of the Invention

The present invention relates to a motor driving apparatus capable of preventing overcurrent from occurring in a driving current while maintaining a target speed.

2. Description of the Related Art

A brushless direct current (BLDC) motor generally refers to a DC motor having a variable function of conducting a current or adjusting a current direction using a non-contact position detector and a semiconductor element, rather than using a mechanical contact such as a brush, a commutator, and the like, in a DC motor.

In order to drive this BLDC motor, a driving apparatus may be used.

FIG. 1 is a configuration diagram of a general motor driving apparatus.

Referring to FIG. 1, the general motor driving apparatus 10 may include a controlling unit 11 and a driving unit 12.

The controlling unit 11 may control driving of the motor, and the driving unit 12 may drive the motor by turning four field effect transistors (FETs) on or off, in response to a driving signal of the controlling unit 11.

FIG. 2 is a diagram showing driving signals of the motor driving apparatus.

Referring to FIG. 2, the driving signals transferred from the controlling unit 11 to the driving unit 12 may be divided into four signal types and transferred in a sequence of identification numerals \textcircled{1}, \textcircled{2}, \textcircled{3}, and \textcircled{4}.

That is, a first PMOS FET P1 and a second NMOS FET N2 may be turned on by a driving signal represented by the identification numeral \textcircled{1}, while the first PMOS FET P1 and the second NMOS FET N2 may be turned off and a second PMOS FET P2 and a first NMOS FET N1 may be turned on by a driving signal represented by the identification numeral \textcircled{2}.

Again, the second PMOS FET P2 and the first NMOS FET N1 may be turned off and the first PMOS FET P1 and the second NMOS FET N2 may be turned on by a driving signal represented by the identification numeral \textcircled{3}, and the first PMOS FET P1 and the second NMOS FET N2 may be turned off and the second PMOS FET P2 and the first NMOS FET N1 may be turned on by a driving signal represented by the identification numeral \textcircled{4}.

In this driving scheme, when the first PMOS FET P1 and the second PMOS FET P2 are turned on, pulse width modulation (PWM) signals (oblique line portions of FIG. 2) are generated, whereby a speed of the motor may be controlled.

FIG. 3 is a general PWM signal on-duty graph.

Referring to FIG. 3, the general PWM signal on-duty graph may be implemented to have a rectangular shape.

However, current flowing in the motor is rapidly changed by this general PWM signal, such that an overcurrent may occur.

In order to prevent this defect, a duty of the PWM signal may also be adjusted in a soft switching scheme.

FIG. 4 is an on-duty graph of a PWM signal to which the soft switching scheme is applied.

Referring to FIG. 4, in the on-duty of the PWM signal to which the soft switching scheme is applied, a duty may be adjusted at a portion at which the signal is ended. However, considering that the speed of the motor is controlled by the on-duty of the PWM signal, the speed of the motor may not be sufficiently controlled to attain a target speed.

### SUMMARY OF THE INVENTION

An aspect of the present invention provides a motor driving apparatus capable of preventing overcurrent from occurring in a driving current while maintaining a target motor speed.

According to an aspect of the present invention, there is provided a motor driving apparatus including: a duty adjusting unit adjusting a duty of a pulse width modulation (PWM) signal in response to a detection signal from a hall sensor, adjusting a duty value in at least a partial period of the entire duty period to be higher than a target duty value that is to be controlled and a duty value in at least another partial period thereof to be lower than the target duty value that is to be controlled, and adjusting an average duty value in the entire duty period to follow the target duty value; a signal generating unit receiving a PWM control signal from the outside and generating the PWM signal of which the duty is adjusted according to the adjustment of the duty by the duty adjusting unit; and a driving controlling unit controlling driving of a motor in response to the detection signal of the hall sensor and the PWM signal of the signal generating unit.

The motor driving apparatus may further include a driving unit driving the motor according to the control of the driving by the driving controlling unit.

The duty adjusting unit may include: a switching signal generator generating switching signals to switch switches driving the motor on or off, in response to the detection signal of the hall sensor; a timer determining a period in which the duty of the PWM signal is adjusted in response to the switching signals of the switching signal generating unit; and a soft switching unit soft-switching the switches driving the motor by adjusting the duty according to the period of the timer.

The signal generating unit may include: a detector detecting the PWM control signal from the outside; and a driving signal generator providing a PWM driving signal according to a detection value from the detector and the adjustment of the duty by the duty adjusting unit.

The driving unit may include: a first PMOS FET electrically connected between a power supply terminal from which power is supplied and a ground; a first NMOS FET electrically connected between the first PMOS FET and the ground; a second PMOS FET connected to the power supply terminal in parallel with the first PMOS FET and electrically connected between the power supply terminal and the ground; and a second NMOS FET electrically connected between the second PMOS FET and the ground.

The PWM driving signal may include a first period from a time at which the PWM signal starts to a preset time, a second period from a time at which the first period ends to another preset time, and a third period from a time at which the second period ends to a time at which the PWM signal ends; a duty value in the first period may be smaller than the target duty value, a duty value in the second period may be larger than the target duty value, and a duty value in the third period may be smaller than the target duty.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a general motor driving apparatus;

FIG. 2 is a diagram showing driving signals of the motor driving apparatus;

FIG. 3 is an on-duty graph of a general PWM signal;

FIG. 4 is an on-duty graph of a PWM signal formed by implementing the soft switching scheme;

FIG. 5 is a configuration diagram of a motor driving apparatus according to an embodiment of the present invention;

FIGS. 6 through 8 are on-duty graphs showing a pulse width modulation (PWM) signal of the motor driving apparatus according to the embodiment of the present invention;

FIG. 9 is a graph showing a driving signal of the motor driving apparatus according to the embodiment of the present invention; and

FIGS. 10A through 10C are, respectively, an actual on-duty graph of a PWM signal to which a soft switching scheme is not applied, an actual on-duty graph of a PWM signal to which a soft switching scheme is applied, and an on-duty graph of the PWM signal of the motor driving apparatus according to the embodiment of the present invention.

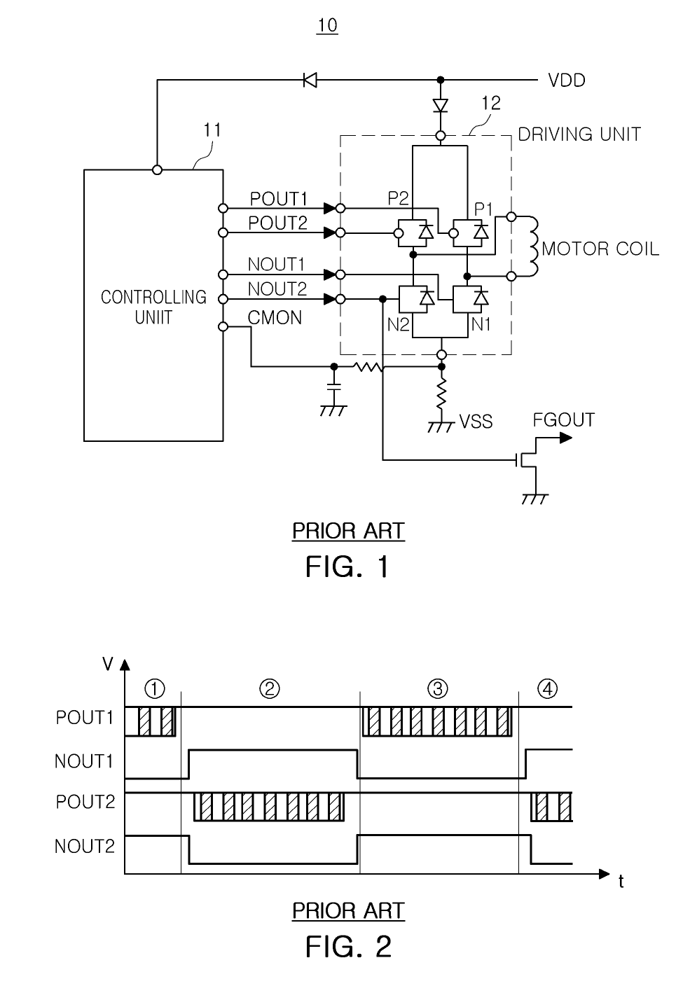

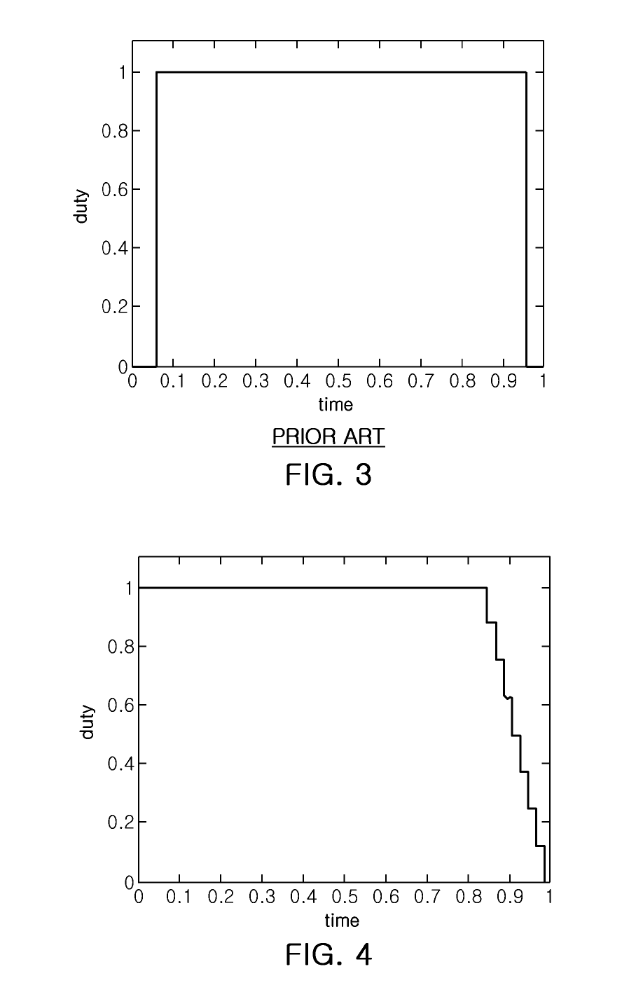

### DETAILED DESCRIPTION OF THE INVENTION

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

A case in which any one part is connected with another part includes a case in which the parts are directly connected with each other and a case in which the parts are indirectly connected with each other with other elements interposed therebetween.

In addition, unless explicitly described otherwise, “comprising” any components will be understood to imply the inclusion of other components but not the exclusion of any other components.

Embodiments of the present invention will now be described in detail with reference to the accompanying drawings.

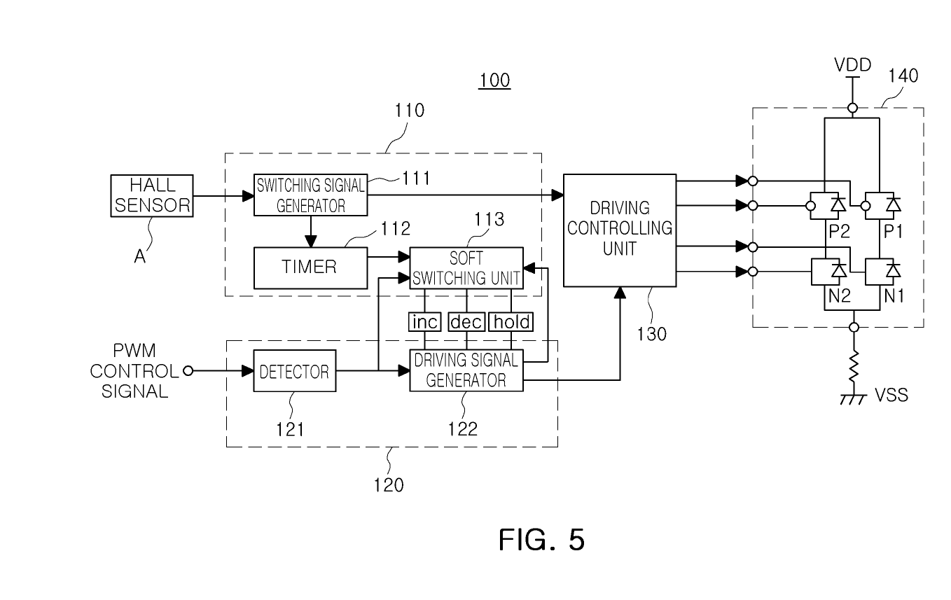

FIG. 5 is a configuration diagram of a motor driving apparatus according to an embodiment of the present invention.

Referring to FIG. 5, the motor driving apparatus 100 according to the embodiment of the present invention may include a duty adjusting unit 110, a signal generating unit 120 and a driving controlling unit 130, and further include a driving unit 140.

The duty adjusting unit 110 may adjust a duty of a pulse width modulation (PWM) signal in response to a detection signal from a hall sensor A.

The duty adjusting unit 110 may include a switching signal generator 111, a timer 112, and a soft switching unit 113.

The switching signal generator 111 may receive the detection signal from the hall sensor A to thereby provide switching signals capable of switching on/off switches of the driving unit 140. The hall sensor A may detect a moment at which magnetic polarity of the motor is changed, and the switching signal generator 111 may recognize a rotational position of the motor by the detection signal of the hall sensor A, to thereby provide switching signals capable of driving the motor.

The timer 112 may determine a period in which the duty of the PWM signal is adjusted in response to the switching signals of the switching signal generator 111. As described above, the switching signals of the switching signal generator 111 may switch the switches of the driving unit 140 on and off, and the timer 112 may determine the period in which the duty of the PWM signal is adjusted by selecting a switching signal capable of adjusting the duty of the PWM signal among the switching signals switching the switches of the driving unit 140 on/off.

The soft switching unit 113 may soft-switch the switches of the driving unit 140 by adjusting the duty according to the duty adjustment period determined by the timer 112. To this end, the soft switching unit 113 may adjust a duty value in at least a partial period of the entire duty period to be higher than a target duty value that is to be controlled and a duty value in at least another partial period thereof to be lower than a target duty value that is to be controlled, and may adjust an average duty value in the entire duty period to follow the target duty value. Here, the meaning of the ‘follow’ is that the average duty value in the entire duty period may be adjusted to coincide with the target duty value or to be similar to the target duty value.

The signal generating unit 120 may provide PWM driving signals soft-switching the switches of the driving unit 140 in response to PWM control signals from the outside and the duty adjustment from the duty adjusting unit 110.

To this end, the signal generating unit 120 may include a detector 121 and a driving signal generator 122.

The detector 121 may detect the PWM control signal to thereby transfer the detected PWM control signal to the driving signal generator 122.

The driving signal generator 122 may perform a PWM control in response to the PWM control signal detected by the detector 121 and set a duty of the PWM driving signal according to the duty adjustment from the duty adjusting unit 110.

That is, the soft switching unit 113 may adjust the duty value of the PWM driving signal to be decreased (dec), increased (inc), or held (hold), and the driving signal generator 122 may provide the PWM driving signal having the duty according to the adjustment, to the driving controlling unit 130.

The driving controlling unit 130 may receive the switching signal from the switching signal generator 111 and the PWM driving signal from the driving signal generator 122, to thereby provide driving signals having a power level capable of driving the switches of the driving unit 140 in response to the switching signal and the PWM driving signal, to the driving unit 140.

The driving unit 140 may include a total of four switches, wherein the four switches may include two P-channel metal oxide semiconductor field effect transistors (PMOS FETs) P1 and P2 and two N-channel metal oxide semiconductor field effect transistors (NMOS FETs) N1 and N2.

A first PMOS FET P1 may be electrically connected between a power supply terminal from which power VDD is supplied and a ground VSS, and a first NMOS FET N1 may be electrically connected between the first PMOS FET P1 and the ground.

A second PMOS FET P2 may be connected to the power supply terminal in parallel with the first PMOS FET P1 and be electrically connected between the power supply terminal and the ground, and a second NMOS FET N2 may be electrically connected between the second PMOS FET P2 and the ground.

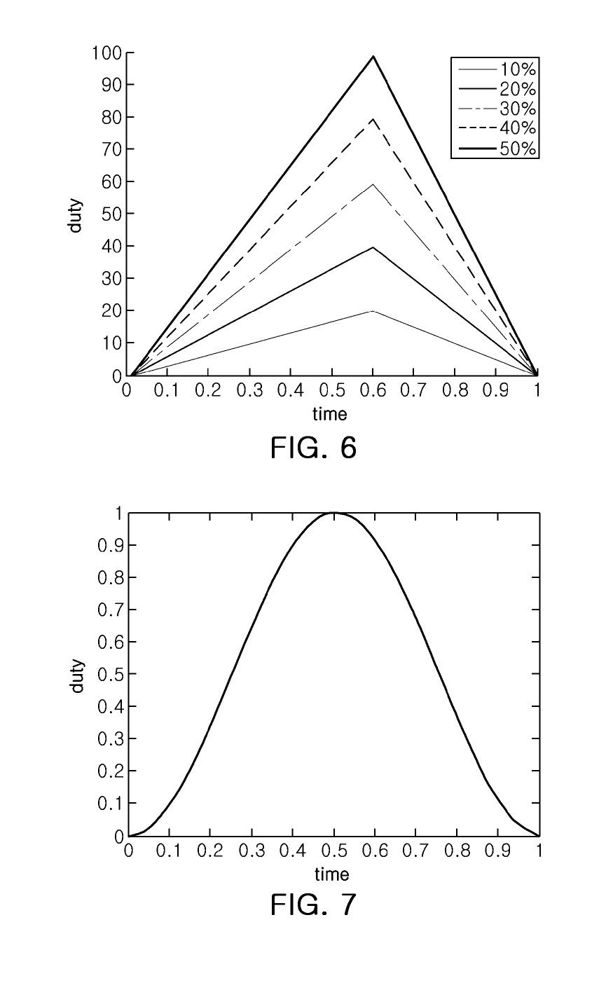

FIGS. 6 through 8 are on-duty graphs showing a pulse width modulation (PWM) signal of the motor driving apparatus according to the embodiment of the present invention.

Referring to FIGS. 6 through 8, the PWM signal of the motor driving apparatus according to the embodiment of the present invention may have first to third periods.

The first period may be a period from a time at which the PWM signal starts to a preset time, the second period may be a period from a time at which the first period ends to another preset time, and the third period may be a period from a time at which the second period ends to a time at which the PWM signal ends. In addition, a duty value in the first period may be smaller than the target duty value, a duty value in the second period may be larger than the target duty value, a duty value in the third period may be smaller than the target duty, and the entire duty value of the PWM signal may be the same or almost approximate to the target duty value.

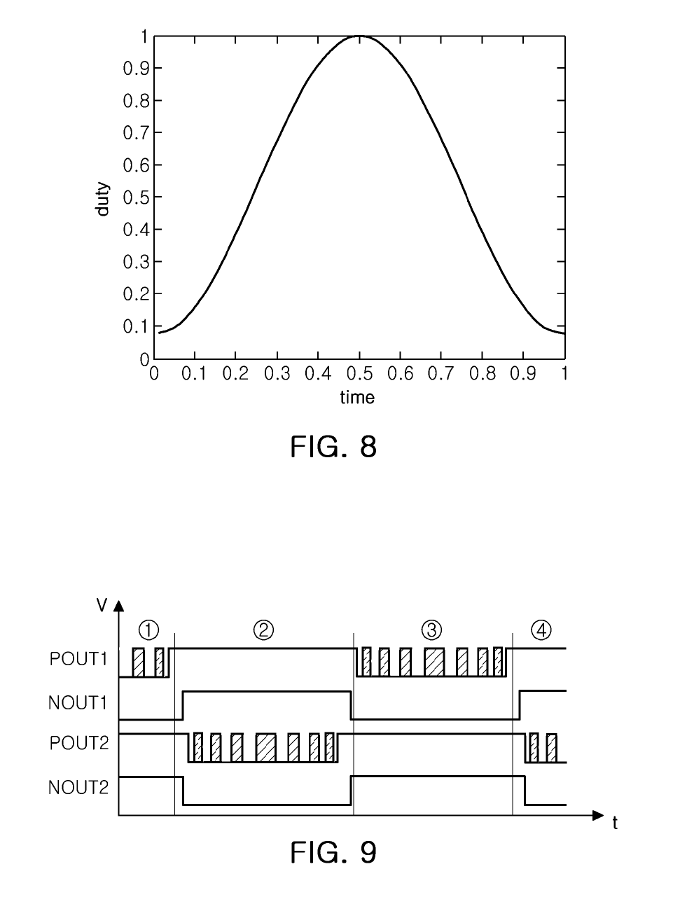

That is, the duty may be adjusted in a triangular wave form as shown in FIG. 6, in a hanning window form as shown in FIG. 7, or in a hamming window form as shown in FIG. 8.

FIG. 9 is a graph showing a driving signal of the motor driving apparatus according to the embodiment of the present invention.

Referring to FIG. 9, the driving signals transferred from the driving controlling unit 130 to the driving unit 140 may be divided into four signal types and be transferred in a sequence of identification numbers \textcircled{1}, \textcircled{2}, \textcircled{3}, and \textcircled{4}.

That is, a first PMOS FET P1 and a second NMOS FET N2 may be turned on by a driving signal represented by the identification numeral \textcircled{1}, and the first PMOS FET P1 and the second NMOS FET N2 may be turned off and a second PMOS FET P2 and a first NMOS FET N1 may be turned on by a driving signal represented by identification numeral \textcircled{2}.

Again, the second PMOS FET P2 and the first NMOS FET N1 may be turned off and the first PMOS FET P1 and the second NMOS FET N2 may be turned on by a driving signal represented by the identification numeral \textcircled{3}, and the first PMOS FET P1 and the second NMOS FET N2 may be turned off and the second PMOS FET P2 and the first NMOS FET N1 may be turned on by a driving signal represented by the identification numeral \textcircled{4}.

In this driving scheme, when the first PMOS FET P1 and the second PMOS FET P2 are turned on, pulse width modulation (PWM) signals (oblique line portions of FIG. 9) may be generated, whereby a speed of the motor may be controlled.

Here, the entire duty of the PWM signal in which the first PMSO FET P1 or the second PMOS FET P2 is turned on may be the same or approximate to the target duty, but each of the duties of the PWM signal in which turn of the first PMOS FET P1 or the second PMOS FET P2 on or off is repeated may be changed, as shown in FIGS. 6 through 8. Therefore, the duty of the PWM signal represented by oblique line portions and corresponding to the time at which the first PMOS FET P1 or the second PMOS FET P2 are turned on may be decreased as it becomes close to points at which the signal turning the first PMOS FET P1 or the second PMOS FET P2 on starts or ends, and may be increased as it becomes distant from the points, and the entire duty may be the same as or approximate to the target duty.

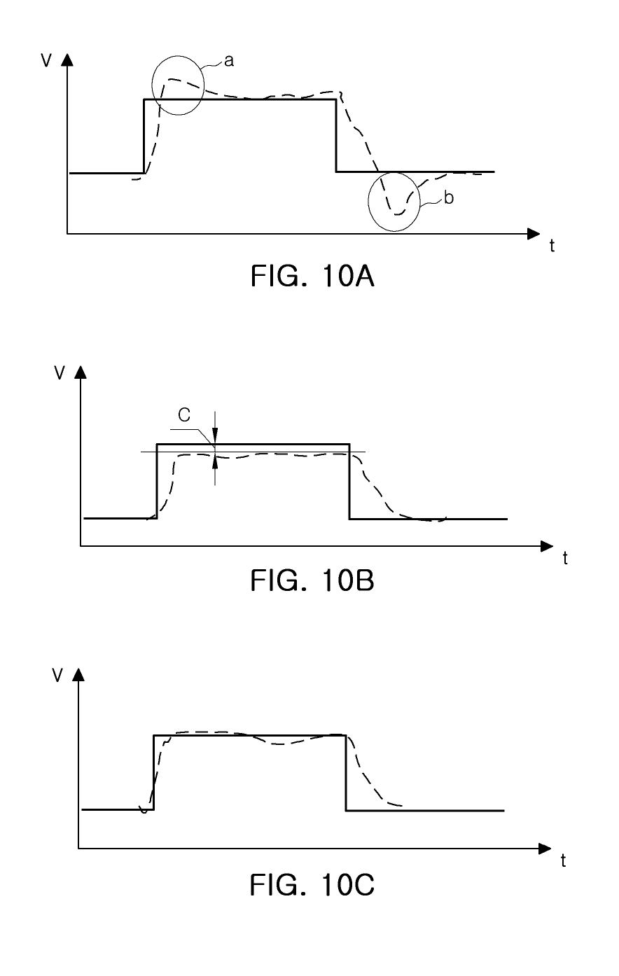

FIGS. 10A through 10C are, respectively, an actual on-duty graph of a PWM signal to which a soft switching scheme is not applied, an actual on-duty graph of a PWM signal to which the soft switching scheme is applied, and an on-duty graph of the PWM signal of the motor driving apparatus according to the embodiment of the present invention.

Referring to FIG. 10A, it may be seen that in the case of a signal waveform (a dotted line) of the actual on-duty of the PWM signal to which the soft switching scheme is not applied, overcurrent a and b occurs at portions at which a signal starts or ends, as compared to a signal waveform of a target PWM signal.

Meanwhile, referring to FIG. 10B, it may be seen that in the case of a signal waveform (a dotted line) of the actual on-duty of the PWM signal to which the soft switching scheme is applied, overcurrent barely occurs in portions at which a signal starts or ends but the PWM signal has a level lower than that of the target PWM signal, as compared to the signal waveform of the target PWM signal.

However, referring to FIG. 10C, it may be seen that in the case of a signal waveform (a dotted line) of the on-duty of the PWM signal of the motor driving apparatus according to the embodiment of the present invention, overcurrent barely occurs at portions at which a signal starts or ends and the PWM signal has the almost same level as that of the target PWM signal, as compared to the signal waveform of the target PWM signal.

As set forth above, according to the embodiments of the present invention, the duty value in at least a partial period of the entire duty period of the PWM signal may be adjusted to be higher than the target duty value that is to be controlled, the duty value in at least another partial period thereof may be adjusted to be lower than the target duty value that is to be controlled, and the average duty value in the entire duty period may be adjusted to be the same as the target duty value, whereby the speed of the motor may be controlled to become a required target speed while a phenomenon that the overcurrent flows due to the soft switching is prevented.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a duty adjusting unit adjusting a duty of a pulse width modulation (PWM) signal in response to a detection signal from a hall sensor, adjusting a duty value in at least a partial period of the entire duty period to be higher than a target duty value that is to be controlled and a duty value in at least another partial period thereof to be lower than the target duty value that is to be controlled, and adjusting an average duty value in the entire duty period to follow the target duty value;
a signal generating unit receiving a PWM control signal from the outside and generating the PWM signal of which the duty is adjusted according to the adjustment of the duty by the duty adjusting unit; and
a driving controlling unit controlling driving of a motor in response to the detection signal of the hall sensor and the PWM signal of the signal generating unit.

2. The motor driving apparatus of claim 1, further comprising a driving unit driving the motor according to the control of the driving by the driving controlling unit.

3. The motor driving apparatus of claim 1, wherein the duty adjusting unit includes:
a switching signal generator generating switching signals to switch switches driving the motor on or off, in response to the detection signal of the hall sensor;
a timer determining a period in which the duty of the PWM signal is adjusted in response to the switching signals of the switching signal generating unit; and
a soft switching unit soft-switching the switches driving the motor by adjusting the duty according to the period of the timer.

4. The motor driving apparatus of claim 1, wherein the signal generating unit includes:
a detector detecting the PWM control signal from the outside; and
a driving signal generator providing a PWM driving signal according to a detection value from the detector and the adjustment of the duty by the duty adjusting unit.

5. The motor driving apparatus of claim 2, wherein the driving unit includes:
a first P-channel metal oxide semiconductor field effect transistor (PMOS FET) electrically connected between a power supply terminal from which power is supplied and a ground;
a first N-channel metal oxide semiconductor field effect transistor (NMOS FET) electrically connected between the first PMOS FET and the ground;
a second PMOS FET connected to the power supply terminal in parallel with the first PMOS FET and electrically connected between the power supply terminal and the ground; and
a second NMOS FET electrically connected between the second PMOS FET and the ground.

6. The motor driving apparatus of claim 4, wherein the PWM driving signal includes a first period from a time at which the PWM signal starts to a preset time, a second period from a time at which the first period ends to another preset time, and a third period from a time at which the second period ends to a time at which the PWM signal ends, and
wherein a duty value in the first period is smaller than the target duty value,
a duty value in the second period is larger than the target duty value, and
a duty value in the third period is smaller than the target duty.
